(19) United States
(12) Patent Application Publication
(10) Pub. No.: US 2009/0175180 A1
(43) Pub. Date: Jul. 9, 2009

(54) Method and System of Addressing a Condition Experienced by a Customer When Using A Network

(75) Inventors: Chen-Yui Yang, Marlboro, NJ (US); Paritosh Bajpay, Edison, NJ (US); Raghvendra Savoor, Walnut Creek, CA (US); Monowar Hossain, Middletown, NJ (US); Vincent C. Tierney, Jr., Pleasant Valley, NJ (US); David H. Lu, Morganville, NJ (US); Xidong Wu, Livermore, CA (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/970,238

(22) Filed: Jan. 7, 2008

(51) Int. Cl. G06F 11/00

(52) U.S. Cl. 370/252

(57) ABSTRACT

A method can be used to address a condition experienced by a customer when using a network. The method can include receiving a first communication from the customer, wherein the first communication is related to the condition of a video content as experienced by the customer, reviewing a log for an alarm, and testing a portion of the network that would process the video content, wherein testing generates a test result. The method can also include correlating the condition to a service parameter, an alarm, a maintenance event, a test result, or any combination thereof. The method can further include sending a second communication to the customer related to the condition. In one embodiment, the method can be fully or partly automated using a system.

### FIELD OF THE DISCLOSURE

The present disclosure generally relates to networks or methods of using the same, and more particularly relates to methods and systems of addressing conditions experienced by customers when using networks.

### BACKGROUND

Delivery of services provided over a network to customers is becoming more competitive as the number of service offerings increases. Many service providers provide telephone services, Internet access, video services, other appropriate services, or any combination thereof to customers. These services may be provided to the customer's premises via a packet-switched network.

Content corresponding to the services can include streaming broadcast video content, video on demand, telephonic data for telephone calls, files (including documents, digital pictures, etc.), or the like. The order in which packets are delivered and reassembled at the customer premises may or may not be a significant problem. For example if packets are dropped and resent for a file, the downloading of the file may be slower, but the contents of the file will be complete when the download is completed. If a packet is dropped during a telephone call, the person listening to the other party speaking may assume that the other party paused for a fraction of a second when talking.

Unlike other content, streaming broadcast video content, such as that provided by Internet Protocol Television, is significantly more sensitive to proper transmission of packets. The customer experiencing the streaming broadcast video content is more likely to notice the problems as compared to other content delivered over the packet-switched network.

Currently, a relatively manual process is used for dealing with conditions experienced by a customer. For example the customer can call a customer care center. After interacting with the customer, the customer service representative can generate a ticket for the condition that the customer is experiencing. The customer service representative may need to classify the condition so that the ticket can be routed to one or more appropriate areas. For example, the ticket may be received by a network administrator to check the network connections that could affect the streaming broadcast video content being sent to the customer premises. Alternatively, or in addition, a technician may be dispatched to address a video ready access device that is located in the field, to the customer premises, or both.

### BRIEF DESCRIPTION OF THE DRAWINGS

Skilled artisans will appreciate that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 includes a block diagram illustrating an embodiment of an Internet protocol television system;

FIG. 2 includes a block diagram illustrating some of the connections between the customer premises and other portions of a network that supports the Internet protocol television system;

FIG. 3 includes an illustration of equipment that can be used at the customer premises;

FIG. 4 includes an illustration of potential interactions between portions of a network in response to a customer request;

FIGS. 5 and 6 include a flow diagram illustrating actions that can be taken in response to a customer request; and

FIG. 7 includes a block diagram of an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, understand that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

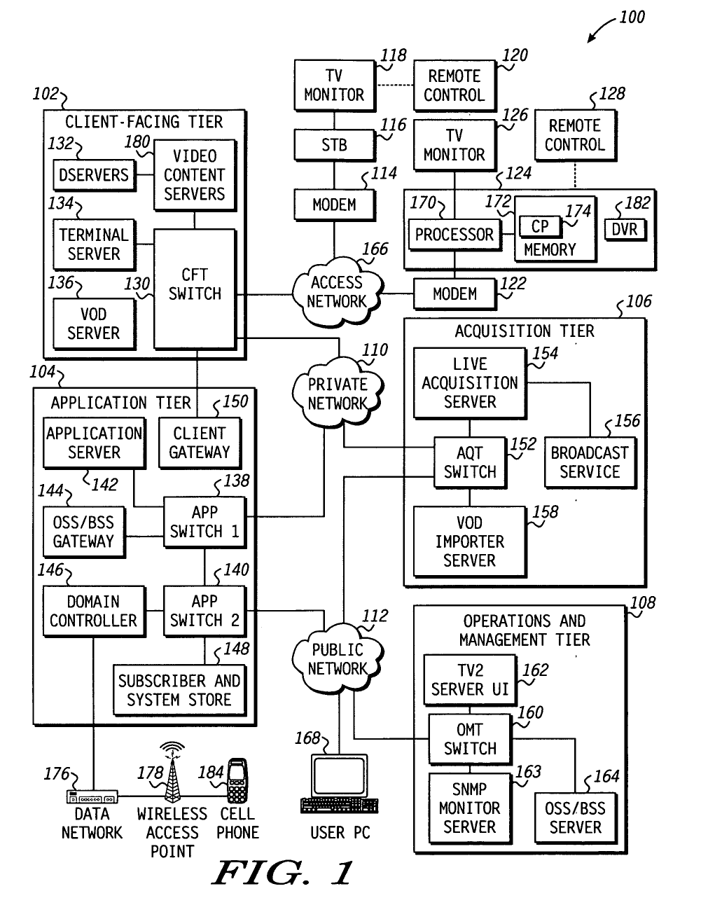

FIG. 1 includes an illustration of an Internet protocol television (“IPTV”) system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to a public network, such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an IPTV network. In an illustrative embodiment, modems, such as a first modem 114 and a second modem 122, can be coupled to the private access network 166. The client-facing tier 102 can communicate with a first representative STB (“STB”) device 116 via the first modem 114 and with a second representative STB device 124 via the second modem 122. The client-facing tier 102 can communicate with a large number of STBs over a wide geographic area, such as a regional area, a metropolitan area, a viewing area, or any other suitable geographic area that can be supported by networking the client-facing tier 102 to numerous STB devices. In one embodiment, the client-facing tier 102 can be coupled to the modems 114 and 122 via fiber optic cables. Alternatively, the modems 114 and 122 can be digital subscriber line (“DSL”) modems that are coupled to one or more network nodes via twisted pairs, and the client-facing tier 102 can be coupled to the network nodes via fiber-optic cables. Each STB device 116 and 124 can process data received from the private access network 166 via an IPTV software platform, such as Microsoft® TV IPTV Edition.

The first STB device 116 can be coupled to a first display device 118, such as a first television monitor, and the second STB device 124 can be coupled to a second display device 126, such as a second television monitor. Moreover, the first STB device 116 can communicate with a first remote control 120, and the second STB device can communicate with a second remote control 128. In an exemplary, non-limiting embodiment, each STB device 116 and 124 can receive data or video from the client-facing tier 102 via the private access network 166 and render or display the data or video at the display device 118 or 126 to which it is coupled. The STB devices 116 and 124 thus may include tuners that receive and decode television programming information for transmission to the display devices 118 and 126. Further, the STB devices 116 and 124 can include an STB processor 170 and an STB memory device 172 that is accessible to the STB processor. In a particular embodiment, the STB devices 116 and 124 can also communicate commands received from the remote controls 120 and 128 back to the client-facing tier 102 via the private access network 166.

In an illustrative embodiment, the client-facing tier 102 can include a client-facing tier (“CFT”) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand (“VOD”) content. The CFT switch 130 can also be coupled to a terminal server 134 that provides terminal devices, such as a game application server and other devices with a common connection point to the private network 110. In a particular embodiment, the CFT switch 130 can also be coupled to a VOD server 136.

The application tier 104 can communicate with both the private network 110 and the public network 112. In this embodiment, the application tier 104 can include a first application tier (“APP”) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the STB devices 116 and 124 via the private access network 166, so the STB devices 116 and 124 can provide functions, such as display, messaging, processing of IPTV data and VOD material. In a particular embodiment, the OSS/BSS gateway 144 includes operation systems and support (“OSS”) data, as well as billing systems and support (“BSS”) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the STB devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen STB devices, from accessing the private network 110, by denying access to these devices beyond the private access network 166.

For example, when the STB device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the STB device 116 access to IPTV content and VOD content. If the client gateway 150 cannot verify subscriber information for the STB device 116, such as because it is connected to a different twisted pair, the client gateway 150 can deny transmissions to and from the STB device 116 beyond the private access network 166.

The acquisition tier 106 includes an acquisition tier (“AQT”) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch 152 can be coupled to a VOD importer server 158 that stores television content received at the acquisition tier 106 and communicate the stored content to the client-facing tier 102 via the private network 110.

The operations and management tier 108 can include an operations and management tier (“OMT”) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (“SNMP”) monitor 163 that monitors network devices. In a particular embodiment, the OMT switch 160 can communicate with the AQT switch 152 via the public network 112.

In a particular embodiment, during operation of the IPTV system, the live acquisition server 154 can acquire television content from the broadcast service 156. The live acquisition server 154 in turn can transmit the television content to the AQT switch 152, and the AQT switch 152 can transmit the television content to the CFT switch 130 via the private network 110. Further, the television content can be encoded at the D-servers 132, and the CFT switch 130 can communicate the television content to the modems 114 and 122 via the private access network 166. The STB devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the STB device 116 or 124, the request can be transmitted over the private access network 166 to the VOD server 136 via the CFT switch 130. Upon receiving such a request, the VOD server 136 can retrieve requested VOD content and transmit the content to the STB device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (“PC”) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices, such as a cellular telephone 180.

In a particular embodiment, the STB devices can include an STB computer program 174 that is embedded within the STB memory device 172. The STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second STB device 124. For instance, in an illustrative embodiment, the account information can relate the user's account to the second STB device 124 by associating the user account with an IP address of the second STB device 124, with data relating to one or more twisted pairs connected with the second STB device 124, with data related to one or more fiber optic cables connected with the second STB device 124, with an alphanumeric identifier of the second STB device 124, with any other data that is suitable for associating second STB device 124 with a user account, or with any combination of these.

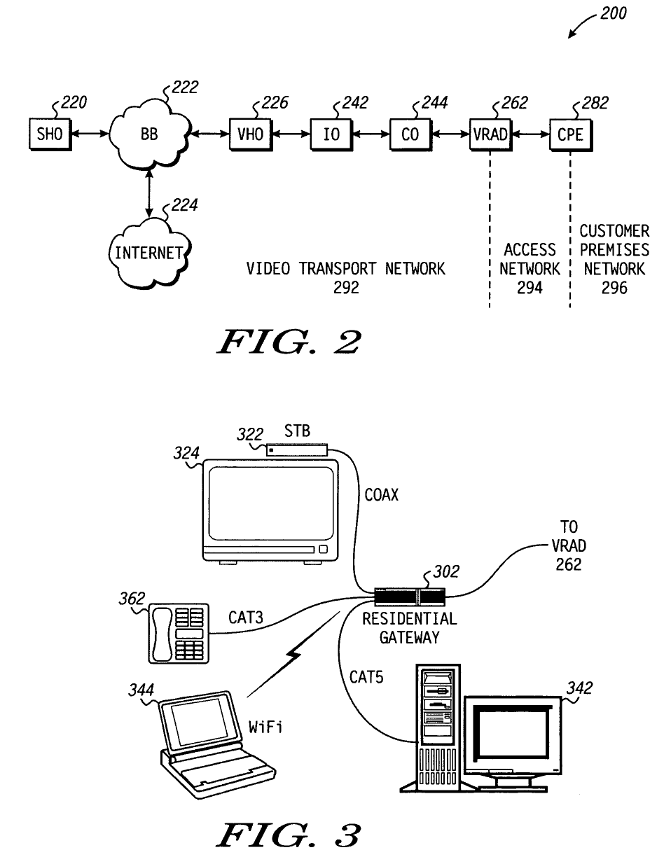

FIG. 2 includes an illustration of a portion of an exemplary network 200 that can be used to deliver digital content, such as IPTV using the IPTV system 100 in FIG. 1, to a customer. The network can include a super hub office (“SHO”) 220 that is bidirectionally coupled to an Internet protocol backbone (“BB”) 222 that is bidirectionally coupled to each of the Internet 224 and a video hub office (“VHO”) 226. In one embodiment, streaming video content provided from national broadcasting networks (e.g., ABC™, CBS™, CNN™, HBO™, etc.) can be sent to and received by the SHO 220. Streaming video content from local broadcasting networks can be sent to and received by the VHO 226. VOD content can be received by and stored within the VHO 226. Internet access can be established via the BB 222 to the Internet 224. Such Internet access can be useful for obtaining files, making calls, requesting other content, or any combination thereof by a customer at the customer premises.

Continuing with the network 200, an intermediate office (“IO”) 242 is by directionally coupled to the VHO 226 and a central office (“CO”) 244. The CO 244 is bidirectionally coupled to a video ready access device (“VRAD”) 262. The VRAM 262 can be similar to a digital subscriber line access multiplexer but is different because the VRAD 262 is particularly designed for streaming broadcast video for IPTV. The VRAD 262 is bidirectionally coupled to customer premises equipment (“CPE”) 282.

Portions of the network 200 can be broken down into smaller networks for purposes of maintaining the network 200. For example, the portion of network 200 that is upstream of the VRAD 262 can be referred to as the video transport network, the portion of the network 200 from the VRAD 262 to the customer premises can be referred to as the access network, and the portion of the network 200 within the customer premises can be referred to as the customer premises network. The significance of the three different portions of the network 200 will become more apparent when describing a process of addressing a condition that is being experienced by a customer when using the customer premises equipment 282 in conjunction with the network 200.

After reading this specification, skilled artisans will appreciate that many different network configurations are possible. For example, VOD content may be accessed by a customer via the Internet 224 or the SHO 220, instead of the VHO 226. No intermediate office or a plurality of intermediate offices similar to the IO 242 may be used. More than one SHO or VHO may also be used. Thus, the particular implementation of a network used to provide services to a customer is variable and can be tailored to the needs or desires of a network operator. Therefore, the network 200 in FIG. 2 is merely for purposes of illustration and is not to be construed as limiting the scope of the present invention.

FIG. 3 includes an illustration of exemplary customer premises equipment that can be used at the customer premises. Within the customer premises, a signal may be routed by a residential gateway 302 to a device within the customer premises. The residential gateway 302 may include a variety of connections to allow different devices, different communication media, or any combination thereof to be used. For example, the residential gateway 302 may be configured to work with a coaxial cable, a Category Five cable, a Category Three cable, a wireless transceiver, another suitable medium for transporting a signal, or any combination thereof. The residential gateway 302 can be bidirectionally coupled to a STB 322 that can be coupled to a monitor 324, such as a television. The residential gateway 302 can be by directionally coupled to a desktop computer 342 via a wireline connection, to a portable device 344 (e.g., a laptop computer, a personal digital assistant, a cellular phone, or another device that includes a processor), or any combination thereof. The residential gateway 302 can be bidirectionally coupled to a telephone 362 via a wireline connection. In another embodiment, more or fewer devices, another type of device, or any combination thereof may be located at the customer premises and may be coupled to the residential gateway 302.

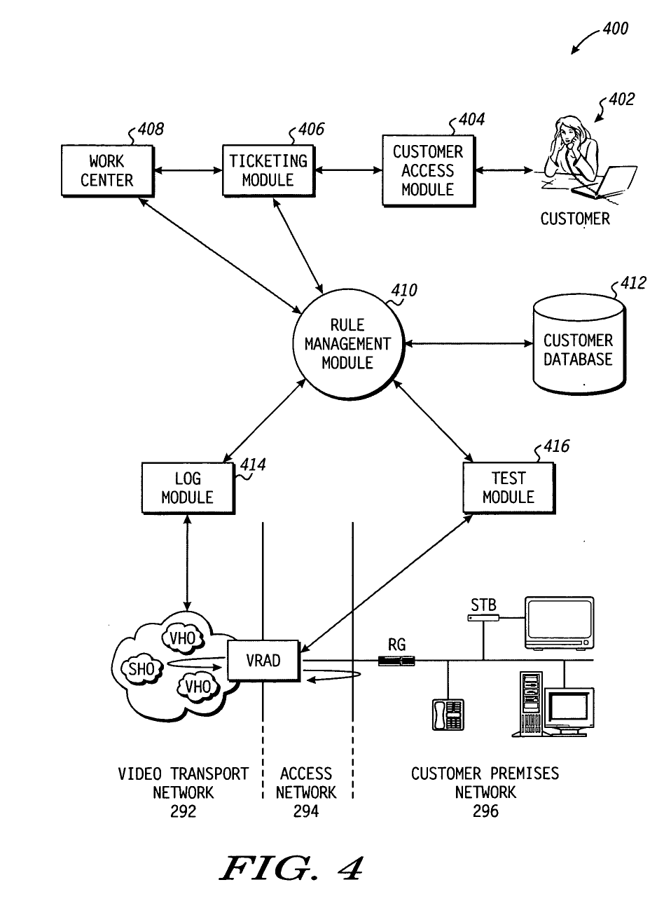

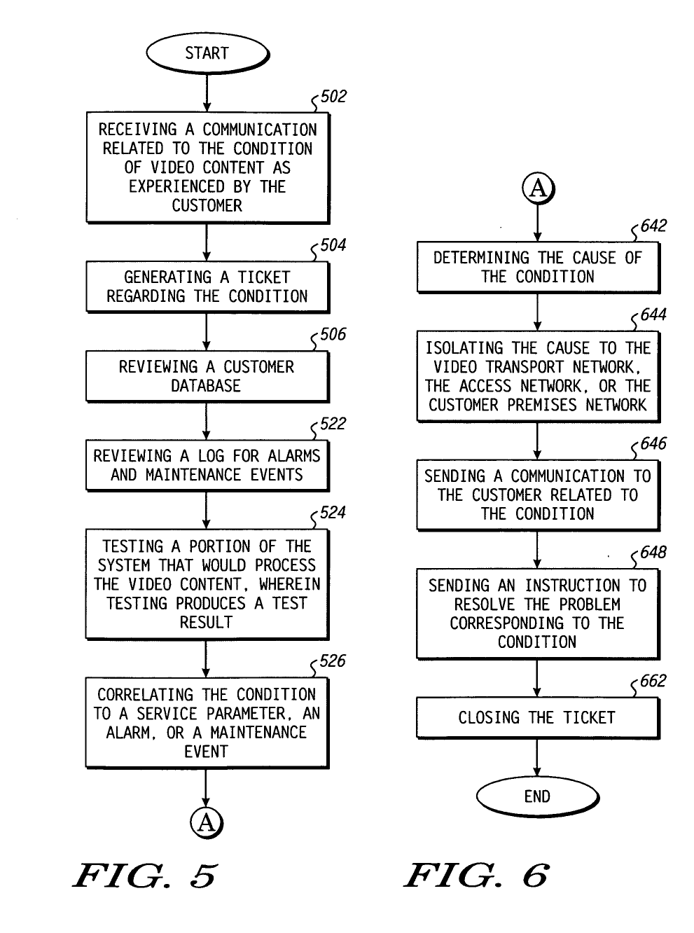

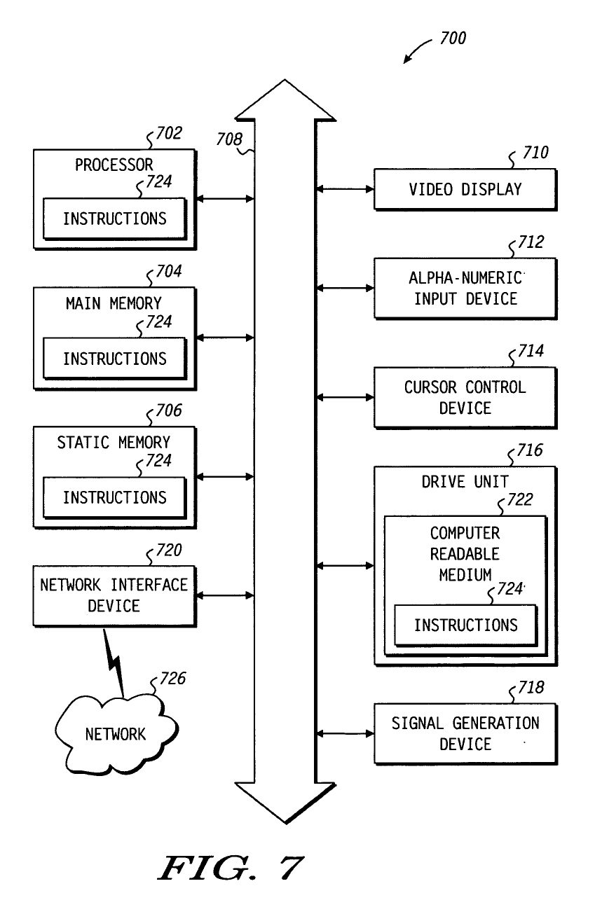

FIG. 4 includes a functional block diagram of an architecture for a system 400 that can be used to address conditions as experienced by a customer at the customer premises. The system 400 can use the network 200 as described with respect to FIGS. 2 and 3. The description of the system 400 and its functionality are described with respect to FIG. 4 and also with respect to an exemplary method of using the system 400 as described with respect to FIGS. 5 and 6.

A customer 402 can communicate with a customer access module 404 using any of the customer premises equipment as previously described with respect to FIG. 3. The customer access module 404 is designed to allow a customer to choose between using a fully automated method, a partially automated method, or interact with a customer service representative. The customer access module 404 is bidirectionally coupled to a ticketing module 406 that can be responsible for generating a ticket, tracking and updating progress of the ticket, and closing the ticket. The ticketing module 406 is bidirectionally coupled to a work center 408 and a rule management module 410. The work center 408 can include personnel to track progress of the ticket, assist in diagnosing the condition experienced by the customer, dispatch a technician, perform another suitable service, or the like.

The rule management module 410 is bidirectionally coupled to a customer database 412, a log module 414, and a test module 416. Some of the functions performed by the rule management module 410 can include determining whether the customer is a current subscriber or is authorized to receive a particular service. The log module 414 may include an entry for an alarm, maintenance, another suitable event, or any combination thereof. The alarm may correspond to any portion of the video transport network 292 and can include alarms from the VRAD. The maintenance entries can include preventive maintenance, scheduled or unscheduled maintenance, upgrades for hardware, software, firmware, or the like. The test module 416 can include logic, hardware, other suitable equipment, or any combination thereof to test any portion of the video transport network 292, the access network 294, the customer premises network 296, or any combination thereof.

The rule management module 410 can correlate the condition experienced by the customer to a service parameter, an alarm, a maintenance event, a test result from the test module 416, or any combination thereof. The rule management module 410 may isolate the source of the condition to a portion of the network (e.g., the video transport network 292, the access network 294, or the customer premises network 296), determined a cause corresponding to the condition, send an instruction to any device within the network 200, generate an instruction for the customer to perform, or any combination thereof.

Although not illustrated, each of the modules may include hardware, software, firmware, or any combination thereof to perform the methods and functions as described herein. Thus, the rule management module 410 can include its own database that can be used to correlate conditions to service parameters, conditions to particular alarms, conditions to particular maintenance events, or the like. Further the rule management module 410 can include a server, a PC, or another computer in a different form (e.g., distributed computing system) to execute the logic used in performing the functions of the rule management module 410. Similarly, the ticketing module 406, the log module 414, and the test module 416 may likewise include their own or a shared database, and include a computing system that may be used by each module individually or shared between modules to execute the logic of functions to be performed by that particular module.

After reading this specification, skilled artisans will appreciate that other architectures can be used. For example, the customer database 412 can be a database that also includes information regarding alarms and maintenance events from the log module 414, test results and tests that can be performed by the test module 416, rules that are to be executed by the rule management module 410, tickets and ticket status information generated or used by the ticketing module 406, or the like. Functionality in one module may be combined with a different module. For example the functions of the log module 414 and the test module 416 could be combined in another embodiment. Functionality in one module could be divided into different modules. For example, the log module 414 could have a module for alarms and another module four maintenance events. Further, functions of different modules may be partitioned in a different manner than illustrated or described. Other configurations can alternatively be used.

The utility of the architecture of the system 400 as illustrated in FIG. 4 will become more apparent with the process flow as described in FIGS. 5 and 6. When the customer accesses the customer access module 404 in FIG. 4, a customer may choose to use the automated system or be routed to a customer service representative. The method in FIGS. 5 and 6 is for an automated system and is described from the perspective of the automated system that receives communications from customers, performs actions, and sends communications to the customers. As described below, information may be accessed by a device within the network. The term “accessing,” with respect to information or other data, is to be broadly construed and includes retrieving, allowing receipt, or otherwise obtaining such information or such other information by a device within the network.

The method can include receiving a communication related to the condition of video content as experienced by the customer, at block 502 of FIG. 5. The condition can be highly variable depending on the customer premises equipment. An exemplary, non-limiting condition can include bad video quality on all channels, no video service, no VOD service, no digital video record function available or malfunction, no picture-in-picture function, no or intermittent service, picture flashes in and out, has blocks on it, is blurry, is frozen, is fuzzy, is jumpy, is too bright or too dark, is weak or washed, pixilation or “blockiness” on all channels, the wrong channel appears, video pixilation, video freeze/black screen—the channel stops, a channel cannot be selected, another suitable condition experienced by the customer, or any combination thereof.

The communication can be in one of many different forms. The communication can include a form with boxes or other selections chosen by the customer. In another embodiment, the communication can include free form text composed by the customer. An example can include “scrambled picture,” “improper color tone,” “grainy picture,” “choppy movement of people or objects when in motion,” another suitable video-related condition, or any combination thereof. If free form text is used, the system 400 may include a natural language processing module to parse the customer's expression of the condition, in accordance with a conventional or proprietary natural language processing technique.

The method can also include generating a ticket regarding the condition, at block 504 in FIG. 5. Referring briefly to FIG. 4, after the customer 402 communicates the condition to the ticketing module 406, the ticketing module 406 can generate the ticket and include the condition as experienced by the customer. The ticket can then be routed from the ticketing module 406 to the rule management module 410.

The rule management module 410 may perform an action or a plurality of actions in series or in parallel with another action. Many of such actions are described herein. The method can include reviewing a customer database, at block 506 in FIG. 5. Referring to FIG. 4, the rule management module 410 can perform a query using the customer database 412 to determine whether the customer is a current subscriber, determine whether a service is to be provided to the customer, or any combination thereof. If a customer is not a current subscriber, no further action needs to be performed by the system. Otherwise, a communication can be sent to the customer that the customer is not a current subscriber. If the customer is a current subscriber but is not subscribed to a particular service (e.g., not to receive a particular premium channel), the rule management module 410 may use this information if the condition is related to that particular service. For example, the customer may have reported a scrambled screen for one or more channels. If the channels are not within the customers subscription plan, a communication can be sent to the customers subscription plan does not include the channels with the scrambled screens. A further communication or link can be sent to the customer to allow the customer to subscribe to the channel or other service if the customer desires.

The method can also include reviewing a log for alarms and maintenance events, at block 522 of FIG. 5. The rule management module 410 can communicate with the log module 414 to determine what alarms and maintenance events that have recently occurred. An exemplary, non-limiting alarm or maintenance event can include a disconnection of a device within the network, reinitialization of a device within the network, inability to reinitialize a device within the network, time a device or portion of the network was unavailable, number of occurrences for loss of frame, loss of link, loss of signal or loss of power, number of failed join requests due to insufficient access permission, error in a configuration profile, number of failed join requests due to excessive number of transmission error rate violations, below the minimum allowable bit rate, number of failed join requests due to insufficient bandwidth, another suitable alarm or maintenance event, or any combination thereof.

In one embodiment, the rule management module 410 can review the log. In this particular embodiment, the log module 414 may provide access to a database or other memory that includes a table, a file, or other information that is stored or controlled by the log module 414. In another embodiment, the rule management module 410 may send a request to the log module 414 for the log module 414 to perform the review. In this particular embodiment, the rule management module 410 may provide a request for information, such as a query, that can be received by the log module 414. The log module 414 may perform a search or otherwise compile information corresponding to the request and send the information to the rule management module 410.

The method can further include testing a portion of the system that would process video content, wherein testing produces a test result, at block 524 in FIG. 5. Referring briefly to FIG. 2, the test may be performed at any one or more of the SHO 220, the BB 222, the VHO 226, the IO 242, the CO 244, the VRAD 262, customer premises equipment, or any combination thereof. The testing can be carried out by the test module 416, and the test results can the stored within the test module 416, may be stored in a database or other memory (not illustrated), and can be forwarded to the rule management module 410. An exemplary, non-limiting test result can include a transmission error rate, difference between signal level and noise level, ethernet frame loss ratio, number of line errors that have been corrected, other suitable test result, or the like.

The network may monitor a service parameter within the network. An exemplary, non-limiting service parameter can include current bit rate, maximum attainable bit rate, ratio of current bit rate to maximum attainable bit rate, line status, line or spectrum profile (noise margin, power, power back off mode, etc.), service profile (data rates, interleaving delay, impulse noise protection level, etc.), current power, current line delay, line impulse noise protection level, attenuation incurred due to a signal as it travels through copper wire, maximum attainable transmitting power, maximum delay allowed for an interleaved channel, maximum allowable noise margin, maximum power spectral density, minimum allowable bit rate, minimum impulse noise protection, minimum allowable noise margin, target noise margin specified by line profile, residential gateway uptime, bytes or packets received/sent/dropped at residential gateway, another suitable service parameter, or any combination thereof.

The method can still further include correlating the condition to a service parameter, an alarm, or a maintenance event, at block 526 in FIG. 5. The rule management module 410 can include logic to perform the correlation. The correlation can include more than one condition, more than one service parameter, more than one alarm, more than one maintenance event, or any combination thereof. The logic can be in the form of hardware, firmware, software, or any combination thereof. The logic can be in the form of rules, policies, or other forms appropriate for making the correlation.

The method can also include determining the cause of the condition, at block 642 of FIG. 6. In one embodiment the rule management module 410 can use the condition and correlated information that may include one or more service parameters, alarms, maintenance events, test results, or the like, and use rules, policies, or other the like to determine the most likely causes of the condition which the customer has experienced. The method can yet further include isolating the cause to the video transport network, the access network, or the customer premises network, at block 644 in FIG. 6. The action taken by an organization operating the system may in part depend on where the cause is located. For example, if the cause is isolated to the video transport network 292, an action can be performed by a system administrator, a technician may be dispatched within a work center or one of the offices within the network to follow up to confirm that the suspected cause is the actual cause or that the problem has been or is being fixed. If the cause is isolated to the video access network 294, a technician may be dispatched to the VRAD 262, where the technician may be able to check the VRAD 262 or a connection between the VRAD 262 and the outside of the customer premises, such as a network interface device at the customer premises. If the cause is isolated to the home network 296, an action may need to be taken within the customer premises.

The method can further include sending a communication to the customer related to the condition, at block 646 in FIG. 6. In one embodiment the communication can include information about repairs or other actions that may be or have been taken by the service provider and may also give the customer and estimated completion time for repairing the condition.

The method can also include sending an instruction to resolve the problem corresponding to the condition, at block 648 in FIG. 6. In one embodiment, the cause may be isolated to the customer premises network 296. The customer may receive an instruction to check a power connection, a network connection, another connection between devices within the customer premises, an instruction to reboot or otherwise reinitialize a device at the customer premises, perform another suitable action, or any combination thereof. Many of the conditions reported by customers are related to conditions within the customer premises. By sending an instruction to the customer to check or perform a relatively simple task, coordinating a time for a service call by a service technician may the avoided. Further, the condition experienced by the customer may disappear or otherwise be resolved in a quicker time frame. In many instances, wires may have come disconnected or otherwise loosened, or a device may have just locked up and simply needs to be rebooted. Customers will appreciate that some conditions may be resolved significantly faster and without having to coordinate schedules of the customer and a service technician of the service provider.

Throughout the method, the ticketing module 406 may have been tracking the progress of actions performed with respect to the ticket. Once the condition experienced by the customer has been repaired or otherwise no longer exists, the ticket in module 406 can close the ticket, as illustrated in block 662 of FIG. 6.

The system and modules described herein can be implemented using a general computing system, and the methods described can be carried out by the general computing system that may be located with in the network.

FIG. 7 includes an illustrative embodiment of a general computer system 700. The computer system 700 can include a set of instructions that can be executed to cause the computer system 700 to perform any one or more of the methods or computer based functions disclosed herein. The computer system 700 may operate as a standalone device or may be connected, such as by using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a desktop PC, a laptop PC, an STB, a personal digital assistant (“PDA”), a mobile device, a palmtop computer, a laptop computer, a desktop computer, a communications device, a wireless telephone, a wireline telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

The computer system 700 may include a processor 702, such as a central processing unit (“CPU”), a graphics processing unit (“GPU”), or both. Moreover, the computer system 700 can include a main memory 704 and a static memory 706 that can communicate with each other via a bus 708. As shown, the computer system 700 may further include a video display unit 710, such as a liquid crystal display (“LCD”), an organic light emitting diode (“OLED”), a flat panel display, a solid state display, or a cathode ray tube (“CRT”). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720 to communicate with a network 726. In a particular embodiment, the disk drive unit 716 may include a computer-readable medium 722 in which one or more sets of instructions 724, such as software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

Embodiments described herein can be used to address more quickly quality of experience conditions as seen by customers and keep the customer informed of the progress. The system can isolate the problem corresponding to the condition relatively quickly. In one embodiment, isolating the problem to a particular portion of the network may be able to be determined in less than approximately 9 minutes, less than approximately 5 minutes, or less than approximately 2 minutes. In a particular embodiment, isolating the problem may take only half minute. A communication can be send to the customer in real time or within a few seconds to let the customer know if the problem is within the customer premises or elsewhere and may include how long the repairs will takes. Customers will appreciate the quick response and being informed of the amount of time repairs will take.

In other embodiments, customers can be instructed to perform one or more relatively simple tasks, such as checking a particular connection, rebooting a device, etc. If the customer desires, he or she can perform the task and get back to enjoying IPTV or other video service quicker than if a technician were dispatched. Additionally, scheduling and premises physical security issues can be avoided.

The system can be flexible enough to allow a customer to talk to a person (e.g., customer service representative) if the customer desires to not use an automated system.

### EXAMPLES

The following specific examples are meant to illustrate particular embodiments and not to limit the scope of the invention.

### Example 1

This Example demonstrates that different types of input from customers can be handled by the system.

In Example 1, a customer notices a condition where the color tones do not appear to be correct. The input from the customer for the communication may be widely varied. For example, the customer can merely note that the color balance appears incorrect, that only green and blue colors are displayed, that no red is displayed, or that “people look sick and pale.” The rule management module 410 can include logic to address natural language processing to determine what is being reported by the customer. From any of the customer inputs, the rule management module 410 will realize that service parameters, alarms, maintenance events, and tests that are related to color balance and tone should be reported back to the rule management module 410 from the block module 414 and the test module 416. If the rule management module 410 isolates the cause to the customer premises network 296, a communication may be sent to the customer to check the red component video connections.

### Example 2

This Example demonstrates that a cause may be isolated, and a technician may be dispatched more precisely to the portion of the network where the cause has been isolated.

In Example 2, a customer may report a condition where the display seen at the customer premises is fuzzy. The rule management module 410 may be able to correlate this condition to an intermittent connection somewhere between the display monitor within the customer premises network 296 and another portion of the network 200. In one embodiment, more than one customer may have reported a similar condition. The rule management module 410 can determine whether the reported conditions are from a single VRAD, a single central office, or another individual device or office within the network. In a particular embodiment, a storm may have caused a tree limb to fall onto an enclosure that includes the VRAD 262. The rule management module 410 will be able to isolate the cause to the VRAD 262 and will send a communication to the work center 408 to dispatch a technician to the VRAD 262. Upon arrival the technician will be able to see that the VRAD 262 was affected by the tree limb and take appropriate action to correct the situation.

### Example 3

This Example demonstrates that the network is operating properly, but the customer may be accessing a service that the customer is not subscribed to receive.

In Example 3, the customer reports a condition where motion on the display as seen at the customer premises is choppy. The rule management module 410 may be able to correlate this condition to a slow or intermittent connection somewhere between the display monitor with in the customer premises network 296 and another portion of the network 200. In one embodiment, the rule management module 410 may determine that the customer 402 is attempting to access a service not supported by the current subscription plan of the customer and may need to subscribe to a larger bandwidth service to properly support the channel. The customer can be sent a communication notifying the customer of the higher speed required to properly access the service, may receive notification of how to subscribe to the service or be provided a link to allow the customer to subscribe to the service, provided another suitable communication, or any combination thereof.

Many different aspects and embodiments are possible. Some of those aspects and embodiments are described below. After reading this specification, skilled artisans will appreciate that those aspects and embodiments are only illustrative and do not limit the scope of the present invention.

In one aspect, a method can address a condition experienced by a customer when using a network. The method can include receiving a first communication from the customer, wherein the first communication is related to the condition of a video content as experienced by the customer. The method can also include reviewing a log for an alarm, testing a portion of the network that would process the video content, wherein testing generates a test result, and correlating the condition to a service parameter. The method can further include sending a second communication to the customer related to the condition. In one embodiment, reviewing the log, testing the portion of the network, corresponding the condition, and sending the second communication are performed by a device within the network. In a particular embodiment, the device may be a single device or a plurality of devices.

In one embodiment of the first aspect, the video content includes a packetized broadcast stream. In another embodiment, the method further includes reviewing a customer database to determine whether the customer is a current subscriber, and whether the customer is currently subscribed to receive a particular service. In still another embodiment, reviewing the log further includes reviewing the log for a maintenance entry.

In a particular embodiment of the first aspect, the method further includes determining a cause of the condition in response to correlating the condition to the service parameter, the test result, the maintenance entry, or any combination of the service parameter and the test result. In a more particular embodiment, the method further includes isolating the cause to a video transport network, an access network, or a customer premises network. In another more particular embodiment, sending the second communication includes sending the second communication no later than approximately 9 minutes after receiving the first communication. In still another more particular embodiment, isolating the cause includes isolating the cause to the customer premises network, and sending the second communication includes sending the second communication that includes an instruction to be performed by the customer.

In a second aspect, a system can address a condition experienced by a customer when using a network. The system can include a customer access module operable to receive a first communication from the customer, wherein the first communication is related to the condition of a video content as experienced by the customer. The system can also include a rule management module coupled to the customer access module and operable to receive a first information regarding an alarm, receive a test result from a test performed a portion of a system, correlate the condition to a service parameter, and send a second communication to the customer related to the condition.

In one embodiment of the second aspect, the video content includes a packetized broadcast stream. In another embodiment, the system further includes a log module operable to record the first information regarding the alarm, send the first information to the rule management module, record a second information regarding a maintenance event, and send the second information to the rule management module. In still another embodiment, the system further includes a test module operable to perform a test on a portion of the system, and generate a test result corresponding to the test. In yet another embodiment, the rule management module is further operable to isolate a problem corresponding to the condition to a video transport network, an access network, or a customer premises network.

In a further aspect of the second aspect, the customer access module is further operable to allow the customer to terminate the customer's interaction with an automated portion of the system and to talk to a customer service representative. In still a further embodiment, the rule management module is further operable to send an instruction to a portion of the system, wherein the instruction is to resolve a problem corresponding to the condition. In a particular embodiment, the system further includes a ticketing module operable to generate a ticket regarding the condition, and close the ticket after the instruction to resolve the problem has been sent.

In a third aspect, a processor readable medium can include code, wherein the code includes instructions for the processor to carry out any of the methods described herein.

Note that not all of the activities described above in the general description or the examples are required, that a portion of a specific activity may not be required, and that one or more further activities may be performed in addition to those described. Still further, the order in which activities are listed are not necessarily the order in which they are performed.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method of addressing a condition experienced by a customer, the method comprising:
receiving a first communication from the customer, wherein the first communication is related to the condition of a video content as experienced by the customer;
reviewing a log for an alarm;
testing a portion of the network that would process the video content, wherein testing generates a test result;
correlating the condition to a service parameter; and
sending a second communication to the customer related to the condition,
wherein reviewing the log, testing the portion of the network, corresponding the condition, and sending the second communication are performed by a device within the network.

2. The method of claim 1, wherein the video content comprises a packetized broadcast stream.

3. The method of claim 1, further comprising reviewing a customer database to determine whether the customer is a current subscriber, and whether the customer is currently subscribed to receive a particular service.

4. The method of claim 1, wherein reviewing the log further comprises reviewing the log for a maintenance entry.

5. The method of claim 4, further comprising determining a cause of the condition in response to correlating the condition to the service parameter, the test result, the maintenance entry, or any combination of the service parameter and the test result.

6. The method of claim 5, further comprising isolating the cause to a video transport network, an access network, or a customer premises network.

7. The method of claim 5, wherein sending the second communication comprises sending the second communication no later than approximately 9 minutes after receiving the first communication.

8. The method of claim 5, wherein:
isolating the cause comprises isolating the cause to the customer premises network; and
sending the second communication comprises sending the second communication that includes an instruction to be performed by the customer.

9. A system to address a condition experienced by a customer, the system comprising:
a customer access module operable to receive a first communication from the customer, wherein the first communication is related to the condition of a video content as experienced by the customer; and
a rule management module coupled to the customer access module and operable to:
receive a first information regarding an alarm;
receive a test result from a test performed a portion of a system;
correlate the condition to a service parameter; and
send a second communication to the customer related to the condition.

10. The system of claim 9, the video content comprises a packetized broadcast stream.

11. The system of claim 9, further comprising a log module operable to:
record the first information regarding the alarm;
send the first information to the rule management module;
record a second information regarding a maintenance event; and
send the second information to the rule management module.

12. The system of claim 9, further comprising a test module operable to:
perform a test on a portion of the system; and
generate a test result corresponding to the test.

13. The system of claim 9, wherein the rule management module is further operable to isolate a problem corresponding to the condition to a video transport network, an access network, or a customer premises network.

14. The system of claim 9, wherein the customer access module is further operable to allow the customer to terminate the customer's interaction with an automated portion of the system and to talk to a customer service representative.

15. The system of claim 9, wherein the rule management module is further operable to send an instruction to a portion of the system, wherein the instruction is to resolve a problem corresponding to the condition.

16. The system of claim 15, further comprising a ticketing module operable to:
generate a ticket regarding the condition; and
close the ticket after the instruction to resolve the problem has been sent.

17. A processor readable medium comprising code, wherein the code includes instructions for the processor to carry out a method comprising:
accessing a first communication from the customer, wherein the communication is related to the condition of a video content as experienced by the customer, wherein the video content comprises a packetized broadcast stream;
accessing a first notification of an alarm;
accessing a test result corresponding to a test performed on a portion of the network;
correlating the condition to a service parameter; and
sending a second communication to the customer related to the condition.

18. The processor readable medium of claim 17, the code includes further instructions for the processor to carry out the method further comprising reviewing a customer database to determine whether the customer is a current subscriber and a service that the customer is currently subscribed to receive.

19. The processor readable medium of claim 17, the code includes further comprising instructions for the processor to carry out the method further comprising accessing a maintenance entry corresponding to maintenance performed on the system.

20. The processor readable medium of claim 19, the code includes further instructions for the processor to carry out the method further comprising determining a cause of the condition in response to correlating the condition to the service parameter, the test result, the maintenance entry, or any combination of the service parameter and the test result.

21. The processor readable medium of claim 20, the code includes further instructions for the processor to carry out the method further comprising isolating the cause to a video transport network, an access network, or a customer premises network.

22. The processor readable medium of claim 20, wherein sending the second communication comprises sending the second communication no later than approximately 9 minutes after receiving the first communication.

23. The processor readable medium of claim 20, wherein:
isolating the cause comprises isolating the cause to the customer premises network; and
sending the second communication comprises sending the second communication that includes an instruction to be performed by the customer.
